(19) United States
(12) Patent Application Publication
(10) Pub. No.: US 2012/0079485 A1
(43) Pub. Date: Mar. 29, 2012

(54) PROCESS DESIGN APPARATUS, AND PROCESS DESIGN METHOD

(75) Inventor: Shinji Kikuchi, Kawasaki (JP)

(73) Assignee: FUJITSU LIMITED, Kawasaki (JP)

(21) Appl. No.: 13/306,580

(22) Filed: Nov. 29, 2011

Related U.S. Application Data
(63) Continuation of application No. PCT/JP2009/060279, filed on Jun. 4, 2009.

(51) Int. Cl. G06F 9/46

(52) U.S. Cl. 718/100

(57) ABSTRACT

A non-transitory computer readable medium storing therein a program causing a computer to execute setting, in accordance with allocation of a task in a process which has at least two tasks as a predetermined processing unit, a constraint which is related to the process or the task or a combination thereof. The program causing a computer to execute generating a process that satisfies the constraint set, on the basis of constraint definition information that defines the constraint.

### CROSS-REFERENCE TO RELATED APPLICATION

This application is a continuation of International Application No. PCT/JP2009/060279, filed on Jun. 4, 2009, the entire contents of which are incorporated herein by reference.

### FIELD

The embodiments discussed herein are directed to a process design program, a process design apparatus, and a process design method.

### BACKGROUND

In a conventional process design related to programming, system operation management, or specific tasks, a person plans and performs extraction and sequence settings of actions executed in a process, by using a process design tool.

In the process design performed by a person, actions executed in a process and previous/next relations between the actions are all manually defined, so that man-hours taken for the process design increase. Furthermore, in the process design performed by a person, when there is an error in an execution sequence of the actions to be executed or when any action to be executed fails to be inserted, it is difficult to detect such actions.

In recent years, there is a technology for designing a process that matches a set initiation condition and a set termination condition. Examples of the technology for designing a process include a design support apparatus that utilizes past design process information. Furthermore, there is a technology related to an autonomic operation management system that detects abnormality caused by a workflow activated in accordance with an operation management policy, and thereafter stops the workflow.
Patent Literature 1: Japanese Laid-open Patent Publication No. 6-19691
Patent Literature 2: Japanese Laid-open Patent Publication No. 2007-4337

However, in the conventional technology described above, there is a problem in that it is difficult to flexibly add or modify conditions related to a process design. More specifically, the process design generally needs a process for narrowing down the conditions to be satisfied by actions or a process by trial and error; therefore, there is a need to modify a designed process under various conditions.

However, in the conventional technology described above, it is only possible to design a process that matches the set initiation condition and the set termination condition. Therefore, it is difficult to flexibly add or modify the conditions during the process design. Because it is difficult to flexibly add or modify the conditions during the process design, it is needed to install an autonomic operation management system according to the conventional technology when an inconsistent process is generated.

### SUMMARY

According to an aspect of an embodiment, a non-transitory computer readable medium includes instructions that cause a computer to execute setting, in accordance with allocation of a task in a process which has at least two tasks as a predetermined processing unit, a constraint which is related to the process or the task or a combination thereof; and generating a process that satisfies the constraint set, on the basis of constraint definition information that defines the constraint.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating a configuration example of a process design apparatus according to a first embodiment;

FIG. 2 is a diagram illustrating a configuration example of a process design apparatus according to a second embodiment;

FIG. 3 is a diagram illustrating an exemplary screen displayed by a display unit;

FIG. 4 is a diagram for explaining a data structure with Alloy language;

FIG. 5 is a diagram illustrating an example of constraint definitions that are contained in constraint definition information in association with icon operations;

FIG. 6 is a diagram illustrating an example of constraint definitions that are contained in the constraint definition information in order to obtain a connection relation between task cards;

FIG. 7 is a diagram for explaining an example of input and output of a data structure;

FIG. 8 is a flowchart for explaining a flow of a process generation process according to the second embodiment;

FIG. 9 is a diagram for explaining task card definitions for generating a process related to server addition;

FIG. 10A is a diagram for explaining a procedure of a process generation process related to the server addition;

FIG. 10B is a diagram for explaining a procedure of the process generation process related to the server addition;

FIG. 10C is a diagram for explaining a procedure of the process generation process related to the server addition;

FIG. 10D is a diagram for explaining a procedure of the process generation process related to the server addition;

FIG. 11A is a diagram illustrating an example of an alternative process;

FIG. 11B is a diagram illustrating an example of an alternative process;

FIG. 12 is a diagram illustrating an example of a warning for urging re-allocation of task cards; and

FIG. 13 is a diagram illustrating a computer that executes a process design process.

### DESCRIPTION OF EMBODIMENTS

Exemplary embodiments of a process design program, a process design apparatus, and a process design method will be explained below with reference to the accompanying drawings.

### [a] First Embodiment

### Configuration of a Process Design Apparatus According to a First Embodiment

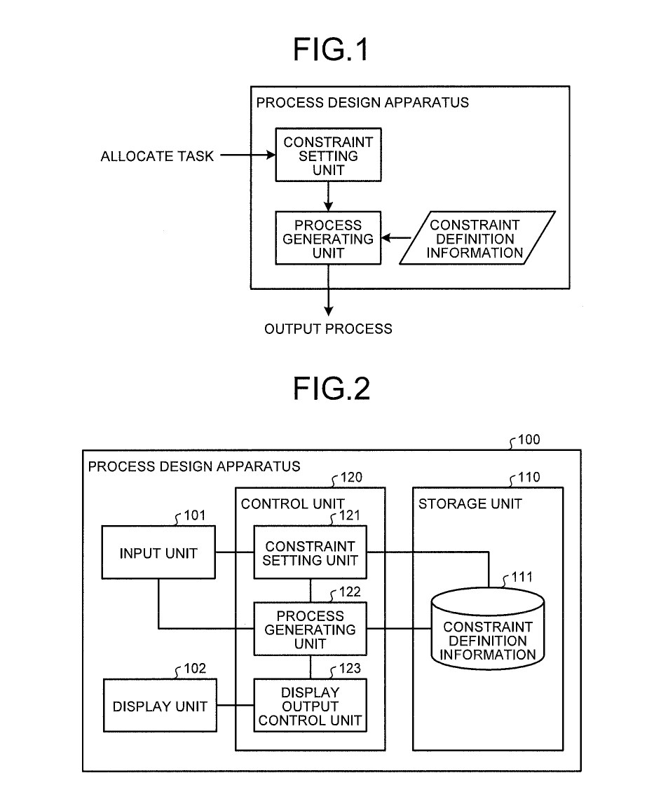

First, a configuration of a process design apparatus according to a first embodiment will be explained with reference to FIG. 1. FIG. 1 is a diagram illustrating a configuration example of the process design apparatus according to the first embodiment.

For example, as illustrated in FIG. 1, the process design apparatus includes a constraint setting unit and a process generating unit. The process design apparatus generates and outputs a process that includes at least two tasks, each of which is a predetermined process unit, in accordance with allocation of the tasks.

In the configuration described above, the process design apparatus sets constraints on a process and/or tasks in accordance with allocation of the tasks in the process that has at least two tasks, each of which is the predetermined process unit. The process design apparatus generates a process that satisfies the set constraints, on the basis of constraint definition information that defines the constraints.

The process generated by the process design apparatus is displayed on a predetermined display device or the like. When the allocation of the tasks contained in the process being displayed on the display device is to be changed, a user re-allocates the tasks by using a predetermined input unit.

### Advantageous Effects According to the First Embodiment

As described above, the process design apparatus sets constraints on the whole process that is generated in accordance with allocation of tasks or constraints on each task, and generates a process that satisfies the constraints on the basis of the constraint definition information that defines the constraints. Therefore, it is possible to flexibly add or modify the conditions related to a process design.

### [b] Second Embodiment

### Configuration of a Process Design Apparatus According to a Second Embodiment

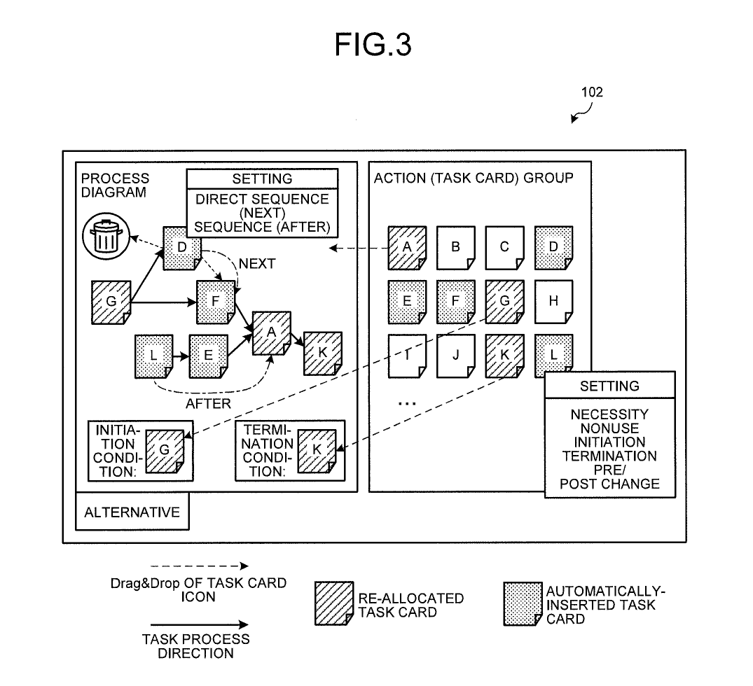

A configuration of a process design apparatus according to a second embodiment will be explained below with reference to FIG. 2. FIG. 2 is a diagram illustrating a configuration example of the process design apparatus according to the second embodiment.

As illustrated in FIG. 2, a process design apparatus 100 includes an input unit 101, a display unit 102, a storage unit 110, and a control unit 120. The process design apparatus 100 is included in, for example, an information processing apparatus, such as a PC (Personal Computer) or a server device, owned by a user who designs a process. In the following, an example will be explained in which Alloy language, which is a description language based on first-order predicate logic and a set theory, is used as a description language for the constraints related to a process generation.

The input unit 101 includes a keyboard or a mouse and receives input of various types of information on the process design apparatus 100. For example, the input unit 101 receives an allocation operation of task cards displayed on the display unit 102 or receives a request to display a process as an alternative for the process being displayed, through the operation using the keyboard or the mouse by a user.

The display unit 102 includes a monitor (or a display, a touch panel, or the like) or a speaker and outputs various types of information on the process design apparatus 100. For example, the display unit 102 displays process diagrams and various warnings controlled by a display output control unit 123, which will be described below.

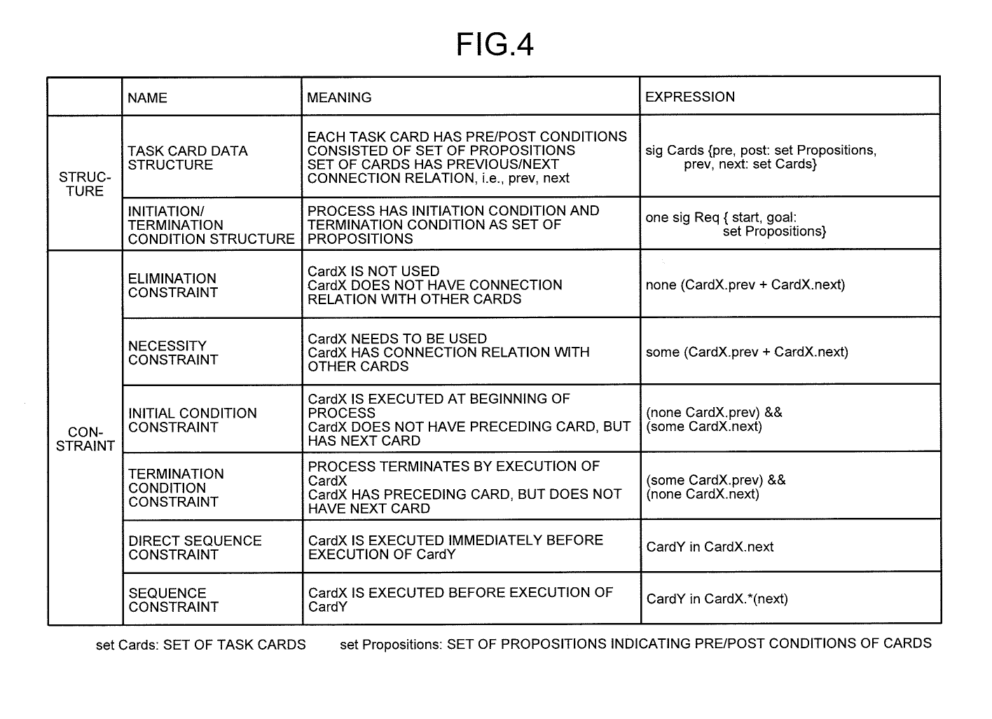

A screen displayed by the display unit 102 is divided into, as illustrated in FIG. 3 for example, a “process diagram”, in which the whole process is displayed as a diagram, and an “action (task card) group”, in which each task is displayed as a graphic. The user sets a card to be used and various conditions, such as initiation conditions and termination conditions, (or allocates the conditions to the process diagram), for each task card contained in the action group, by using the input unit 101.

The user determines a process sequence or eliminates any task with respect to the task cards contained in the process diagram, by using the input unit 101. In FIG. 3, task cards that are allocated by the user are indicated by oblique lines and cards that are automatically inserted are indicated by hatching. Furthermore, in FIG. 3, Drag & Drop of task cards is indicated by dashed arrows, and task process directions are indicated by solid arrows. Meanwhile, FIG. 3 is a diagram illustrating an exemplary screen displayed by the display unit 102.

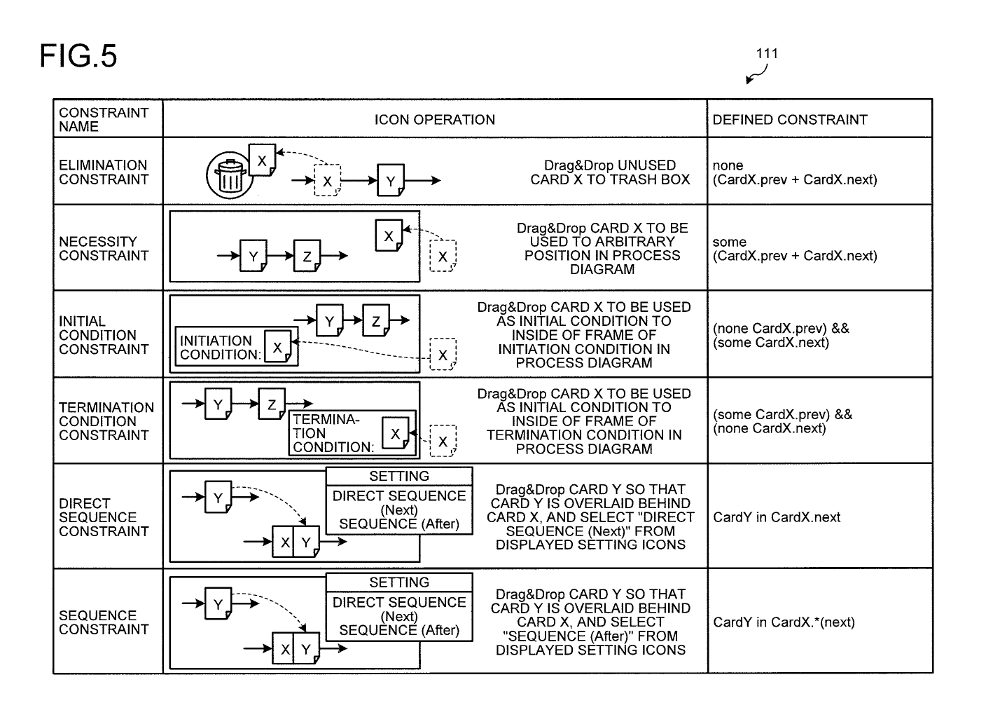

A data structure with Alloy language will be explained below with reference to FIG. 4. FIG. 4 is a diagram for explaining the data structure with Alloy language.

For example, as illustrated in FIG. 4, the data structure with Alloy language is divided into a structure and a constraint. The structure includes a “task card data structure” and an “initiation/termination condition structure”. The task card data structure has a previous/next connection relation with respect to a pre-condition and a post-condition of a task card. The initiation/termination condition structure has an initiation condition and a termination condition in a process.

The constraint includes an “elimination constraint”, a “necessity constraint”, an “initial condition constraint”, a “termination condition constraint”, a “direct sequence constraint”, and a “sequence constraint”. The elimination constraint is a constraint in which a task card does not have a connection relation with other task cards. The necessity constraint is a constraint in which a task card has a connection relation with other task cards.

The initial condition constraint is a constraint in which a task card is executed at the beginning of a process. The termination condition constraint is a constraint in which a task card is executed at the end of a process. The direct sequence constraint is a constraint in which a task card is executed immediately before a predetermined task card. The sequence constraint is a constraint in which a task card is executed before a predetermined task card. The structures and the constraints described above are expressed in Alloy language as illustrated in FIG. 4.

The storage unit 110 stores data needed for various processes performed by the control unit 120 and various process results obtained by the control unit 120, and in particular, stores constraint definition information 111.

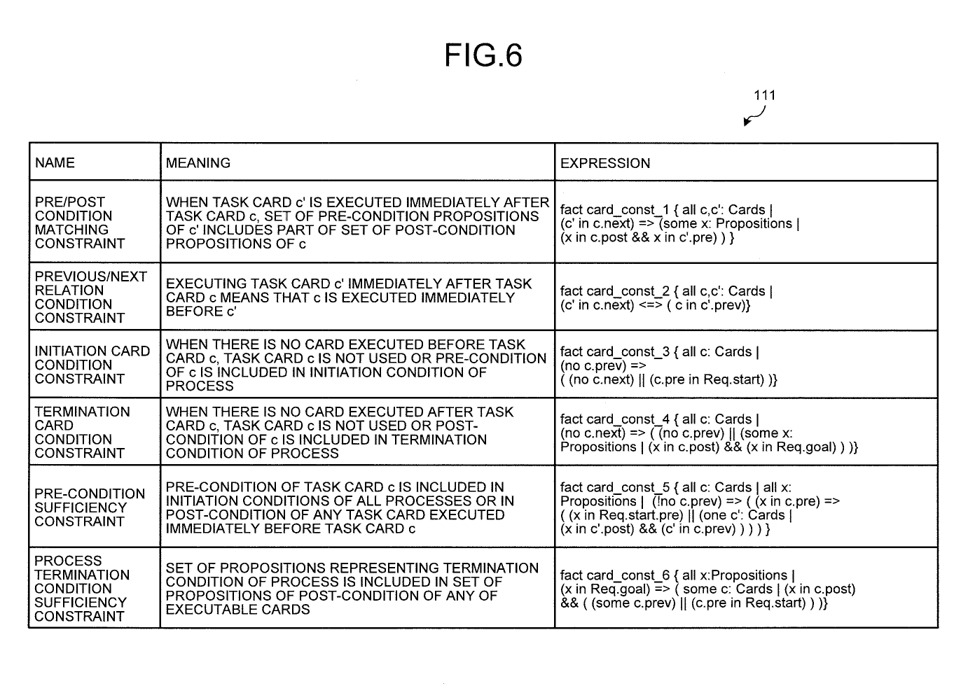

The constraint definition information 111 has, as illustrated in FIG. 5, constraint definitions corresponding to respective icon operations. More specifically, the constraint definition information 111 has the elimination constraint “none (CardX.prev+CardX.next)” that is defined in association with deletion of an unexecuted task, i.e., an icon operation of Drag & Drop of an unused task card X to a trash box. Here, “none” indicates that a set is empty and “+” indicates a combination (union) of sets.

The constraint definition information 111 has the necessity constraint “some (CardX.prev+CardX.next)” that is defined in association with a task that needs to be executed, i.e., an icon operation of Drag & Drop of a task card X, which is to be used, to an arbitrary position in a process diagram. The constraint definition information 111 has the initial condition constraint “(none CardX.prev) && (some CardX.next)” that is defined in association with a task to be executed at the beginning of a process, i.e., an icon operation of Drag & Drop of a task card X, which is to be used as the initial condition, to the inside of a frame of the initiation condition in the process diagram. Here, “some” indicates that a set is not empty.

The constraint definition information 111 has the termination condition constraint “(some CardX.prev) && (none CardX.next)” that is defined in association with a task to be executed at the end of a process, i.e., an icon operation of Drag & Drop of a task card X, which is to be used as the initiation condition, to the inside of a frame of the termination condition in the process diagram. The constraint definition information 111 has the direct sequence constraint “CardY in CardX.next” that is defined in association with execution of a task immediately before a predetermined task, i.e., an icon operation of Drag & Drop that is performed so that the task card Y is overlaid behind a task card X and an icon operation of selection of “direct sequence (Next)” from displayed setting icons.

The constraint definition information 111 has the sequence constraint “Card Y in CardX.*(next)” that is defined in association with execution of a task before a predetermined task, i.e., an icon operation of Drag & Drop that is performed so that a task card Y is overlaid behind a task card X and an icon operation of selection of “sequence (After)” from displayed setting icons. Meanwhile, FIG. 5 is a diagram illustrating an example of the constraint definitions that are contained in the constraint definition information 111 in association with the respective icon operations.

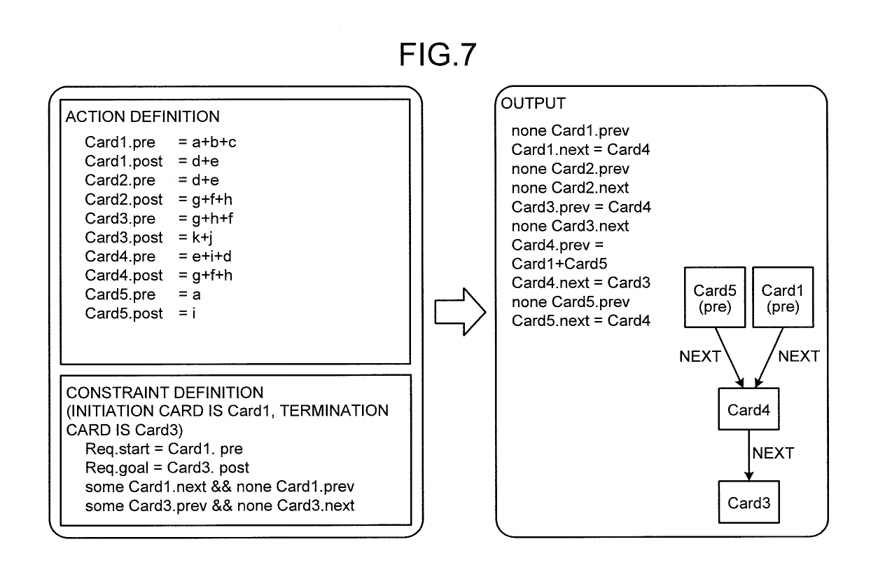

The constraint definition information 111 also has, as illustrated in FIG. 6, a pre-condition and a post-condition of a task and has constraints defined by these conditions. More specifically, when a task card c′ is executed immediately after a task card c, the constraint definition information 111 has a “pre/post-condition matching constraint”, in which a part of a set of propositions of the pre-condition of c is included in a set of propositions of the post-condition of c′.

When the task card c′ is executed immediately after the task card c, the constraint definition information 111 has a “previous/next relation condition constraint”, in which the task card c is executed immediately before the task card c′. When there is no task card that is executed before the task card c, the constraint definition information 111 has an “initiation card condition constraint”, in which the task card c is not used or the pre-condition of the task card c is included in the initiation condition of a process.

When there is no task card that is executed after the task card c, the constraint definition information 111 has a “termination card condition constraint”, in which the task card c is not used or the post-condition of the task card c is included in the termination condition of a process. The constraint definition information 111 also has a “pre-condition sufficiency constraint”, in which the pre-condition of the task card c is included in the initiation conditions of all processes or in the post-condition of any of task cards that are executed immediately before the task card c.

The constraint definition information 111 also has a “process termination condition sufficiency constraint”, in which a set of propositions representing the termination condition of a process is included in a set of propositions of the post-condition of any of executable task cards. In other words, the constraint definition information 111 has icon operations on a predetermined task card and various types of constraint definition information that satisfies a process that is needed by the icon operations. Meanwhile, FIG. 6 is a diagram illustrating an example of the constraint definitions that are contained in the constraint definition information 111 in order to obtain a connection relation between task cards.

Referring back to FIG. 2, the control unit 120 includes an internal memory for storing a control program, a program defining various process procedures, and needed data, and in particular, includes a constraint setting unit 121, a process generating unit 122, and a display output control unit 123.

For a concrete example, when Drag & Drop of a task card X to a trash box is performed, the constraint setting unit 121 sets the elimination constraint “none (CardX.prev+CardX.next)” indicating nonuse of the task card X. The constraint setting unit 121 is one example of the control setting unit of the first embodiment.

The process generating unit 122 generates a process, as a process that satisfies the constraint set by the constraint setting unit 121, by allocating a task card Y and a task card Z at a location where the task card X has been allocated until the elimination, on the basis of the constraint definition information 111.

With regard to the task card Y and the task card Z that are newly allocated, when, for example, the task card X has the pre-condition “X1” and the post-conditions “X2” and “X3”, the pre-condition of each of the task card Y and the task card Z becomes “X1”, the post-condition of the task card Y becomes “X2”, and the post-condition of the task card Z becomes “X3”. In other words, the task card Y and the task card Z are task cards that satisfy the whole process including the eliminated task card X and all task cards.

When there is no task card that satisfies the constraints set by the constraint setting unit 121, that is, when there is no process, the process generating unit 122 notifies the display output control unit 123 of absence of the process. When the input unit 101 receives a display output request for a process that is to be an alternative for the process being displayed by the display unit 102, the process generating unit 122 generates a process that satisfies constraints different from the constraints of the process being displayed. The display request for the alternative process is performed by pressing an alternative button illustrated in FIG. 3. The process generating unit 122 is one example of the process generating unit of the first embodiment.

Subsequently, the display output control unit 123 displays, as a graphic, the process generated by the process generating unit 122 on the display unit 102. The graphical form displayed on the display unit 102 is not limited to the form illustrated in FIG. 3.

When notified, by the process generating unit 122, of the absence of the process that satisfies the constraints, the display output control unit 123 causes the display unit 102 to display a warning for urging re-allocation of the task cards.

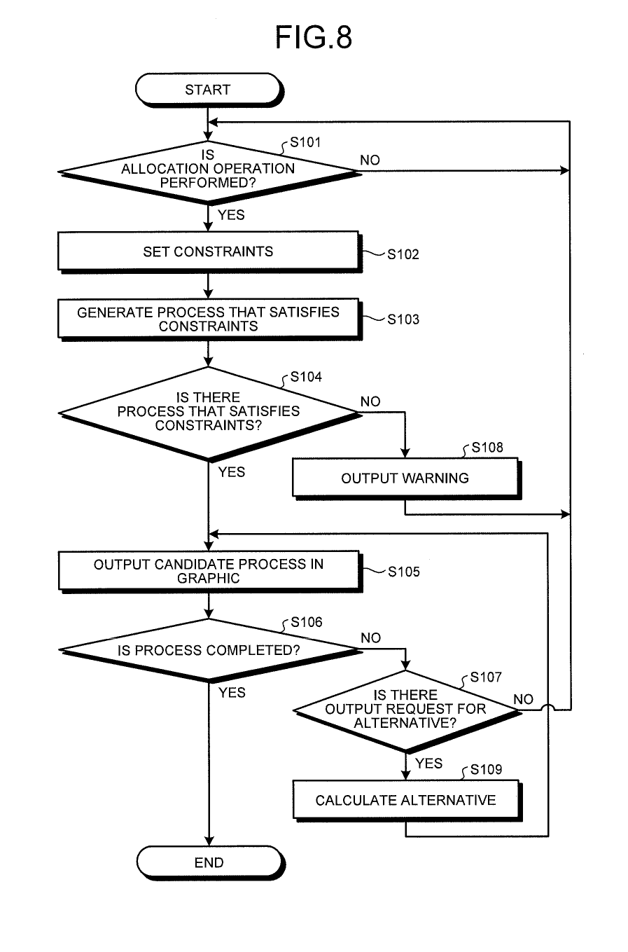

With reference to FIG. 7, an example of a data structure will be explained, which is subjected to the above process in accordance with input using Alloy language and is output. FIG. 7 is a diagram for explaining an example of input and output of a data structure.

For example, as illustrated in FIG. 7, with regard to the input of a data structure, there are an action definition (a task card definition) and a constraint definition according to allocation of task cards. More specifically, there are a definition for each of task cards “1” to “5” and a constraint definition in which the task card “1” is set to the initiation condition and the task card “3” is set to the termination condition.

As an example of the action definition, the task card “1” has a pre-condition “Card1.pre” that indicates “a+b+c”, i.e., a union of the sets “a”, “b”, and “c”, and has a post-condition “Card1.post” that indicates “d+e”, i.e., a union of the sets “d” and “e”. As an example of the constraint condition, there is an initiation condition “Req.start” that indicates “Card1.pre” and “some Card1.nest && none Card1.prev” and there is a termination condition “Req.goal” that indicates “Card3.post” and “some Card3.prev && none Card3.nest”. The constraint definition is visually set through an icon operation using GUI (Graphical User Interface) by a user.

The process design apparatus 100 derives the pre-condition “prey” or the connection relation “next” between the task cards “C1” to “C5”, outputs a process structure that satisfies each of the set constraint definitions, and outputs a graph representation of the process.

Process Generation Process

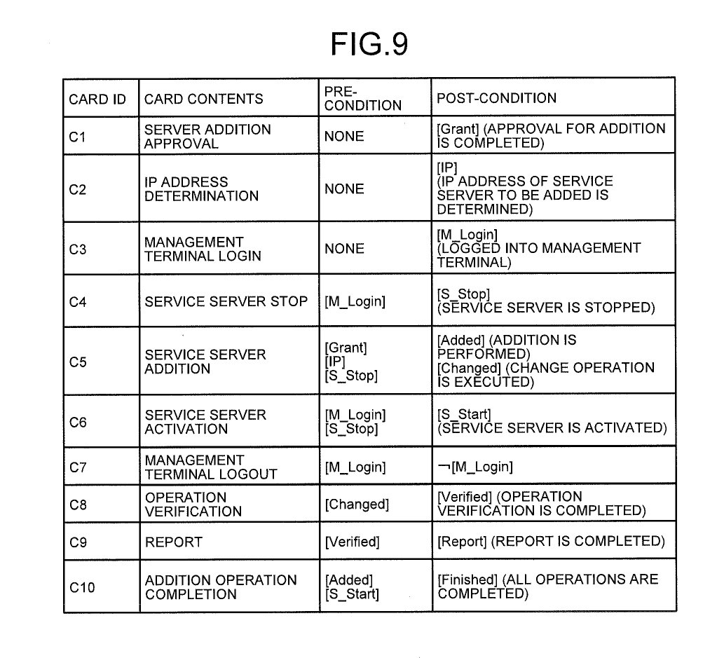

A flow of the process generation process according to the second embodiment will be explained below with reference to FIG. 8. FIG. 8 is a flowchart for explaining a flow of the process generation process according to the second embodiment.

For example, as illustrated in FIG. 8, when a user performs an allocation operation of task cards displayed by the display unit 102 (YES at Step S101), the process design apparatus 100 sets constraints according to the allocation of the task cards (Step S102).

The process design apparatus 100 generates a process that satisfies the set constraints on the basis of constraint definition information contained in the constraint definition information 111 (Step S103). Subsequently, the process design apparatus 100 determines whether there is a process that satisfies the set constraints or not (Step S104). When there is the process (YES at Step S104), the process design apparatus 100 displays the generated process as a candidate on the display unit 102 (Step S105).

When there is no process that satisfies the constraints (NO at Step S104), the process design apparatus 100 outputs a warning for urging re-allocation of the task cards on the display unit 102 (Step S108), and executes the process at Step S101.

Thereafter, when the user does not perform any arbitrary operations for storing the process or terminating the process design (NO at Step S106), the process design apparatus 100 determines whether there is an output request for an alternative process (Step S107).

When the user presses an alternative button to request to output the alternative process (YES at Step S107), the process design apparatus 100 calculates the alternative process, which is different from the process displayed on the display unit 102, on the basis of the constraint definition information contained in the constraint definition information 111 (Step S109), and executes the process at Step S105.

When the user performs arbitrary operations for storing the process or terminating the process design (YES at Step S106), the process design apparatus 100 terminates the process. When there is no output request for the alternative process (NO at Step S107), the process design apparatus 100 executes the process at Step S101. However, when there is no output request for the alternative process, it may be possible to display a message for confirming whether the process design process can be terminated or not on the display unit 102 and terminate the process in accordance with the confirmation.

Example of Process Generation According to Server Addition

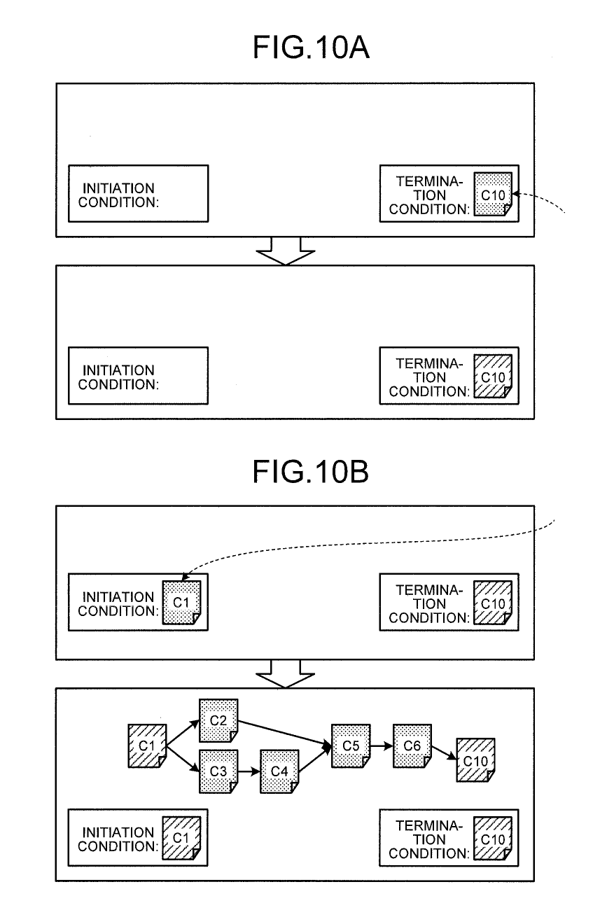

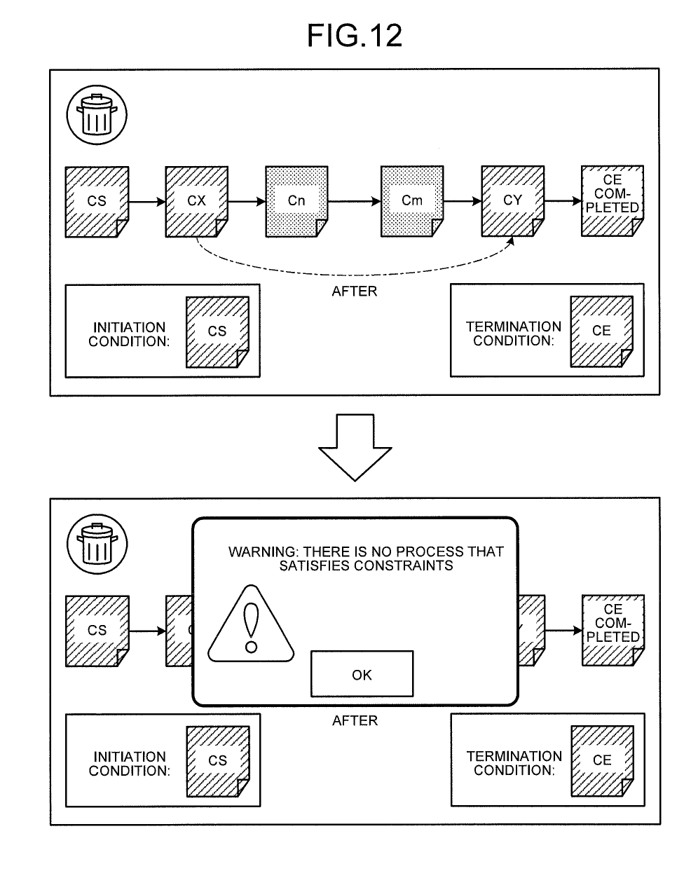

As an example of the application of the process design process, a case will be explained below with reference to FIGS. 9 to 12, in which the above process generation process is applied to a process design for adding a server. FIG. 9 is a diagram for explaining task card definitions for generating a process related to server addition. FIGS. 10-1 to 10-4 are diagrams for explaining a procedure of the process generation process related to the server addition. FIGS. 11-1 to 11-2 are diagrams illustrating an example of an alternative process. FIG. 12 is a diagram illustrating an example of a warning for urging re-allocation of task cards.

Task Card Definitions

A case will be explained in which, for example, task cards with IDs “C1” to “C10” as illustrated in FIG. 9 are provided as task cards used for the process generation related to the server addition. The task card with the ID “C1” indicates a task of server addition approval and has a pre-condition “none” and a post-condition “Grant (approval for addition is completed)”. The task card with the ID “C2” indicates a task of IP address determination and has a pre-condition “none” and a post-condition “IP (IP address of a service server to be added is determined)”.

The task card with the ID “C3” indicates a task of management terminal login and has a pre-condition “none” and a post-condition “M_Login (logged into a management terminal)”. The task card with the ID “C4” indicates a task of service server stop and has a pre-condition “M_Login (logged into a management terminal)” and a post-condition “S_Stop (service server is stopped)”.

The task card with the ID “C5” indicates a task of service server addition and has pre-conditions “Grant (approval for addition is completed)” and “IP (IP address of a service server to be added is determined)” and post-conditions “Added (addition is performed)” and “Changed (change operation is executed)”.

The task card with the ID “C6” indicates a task of service server activation and has pre-conditions “M_Login (logged into a management terminal)” and “S_Stop (service server is stopped)” and a post-condition “S_Start (service server is activated)”. The task card with the ID “C7” indicates a task of management terminal logout and has a pre-condition “M_Login (logged into a management terminal)” and “S_Stop (service server is stopped)” and a post-condition “ [symbol] M_Start (not logged into a management terminal)”.

The task card with the ID “C8” indicates a task of operation verification and has a pre-condition “Changed (change operation is executed)” and a post-condition “Verified (operation verification is completed)”. The task card with the ID “C9” indicates a task of report and has a pre-condition “Verified (operation verification is completed)” and a post-condition “Report (report is completed)”. The task card with the ID “C10” indicates a task of addition operation completion and has pre-conditions “Added (addition operation is executed)” and “S_Start (service server is activated)” and a post-condition “Finished (all operations are completed)”.

Procedure of the Process Generation Process

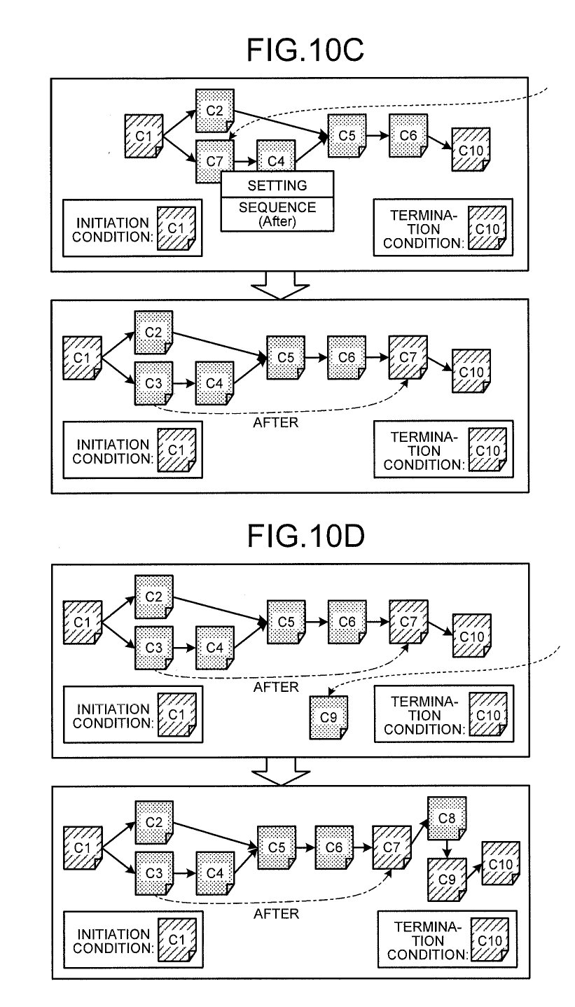

When, for example, the task card with the ID “C10” is placed in the frame of the termination condition by Drag & Drop as illustrated in FIG. 10-1, the process design apparatus 100 sets a termination condition constraint “(some C10.prev) && (none C10.next)” in accordance with the definition of each of the above task cards. At this time, because the initiation condition is not set, the process design apparatus 100 does not derive a process that satisfies this constraint.

Subsequently, when the task card “C1” is placed in a frame of the initiation condition by Drag & Drop as illustrated in FIG. 10-2, the process design apparatus 100 additionally sets an initial condition constraint “(none C1.prev) && (some C1.next)”. Thereafter, as illustrated in FIG. 10-2, the process design apparatus 100 inserts the satisfactory task cards “C2”, “C3”, “C4”, “C5”, and “C6” in accordance with the constraint settings of the initiation condition and the termination condition, thereby generating a process.

Subsequently, as illustrated in FIG. 10-3, when the task card “C7” is overlaid behind the task card “C3” and an icon setting “sequence (After)” is selected, the process design apparatus 100 additionally sets a necessity constraint “some (C1.prev+C7.next)” and a sequence constraint “C7 in C3.*(next)”. At this time, as illustrated in FIG. 10-3, the process design apparatus 100 inserts the task card “C7” to an appropriate position on the downstream side of the task card “C3” in the process.

Subsequently, as illustrated in FIG. 10-4, when the task card “C9” is placed at an arbitrary position in the process diagram by Drag & Drop, the process design apparatus 100 additionally sets a necessity condition “come (C9.prev+C9.next)”. Thereafter, as illustrated in FIG. 10-4, the process design apparatus 100 inserts the task card “C8” that satisfies the constraint setting of the task card “C9”, that is, that is needed to satisfy the pre-condition of the task card “C9”, and allocates the task cards “C8” and “C9” at appropriate positions. When the process generation is completed, the process design apparatus 100 terminates the process.

In other words, when generating a process having 10 task cards related to server addition, the process design apparatus 100 generates a process at four steps, i.e., the initiation condition, the termination condition, the login (logout), and the report of the operations. Therefore, it is possible to largely reduce man-hours taken for the process generation compared with the conventional technology in which one to twenty steps are needed for allocating one icon (card and arrows).

Alternative

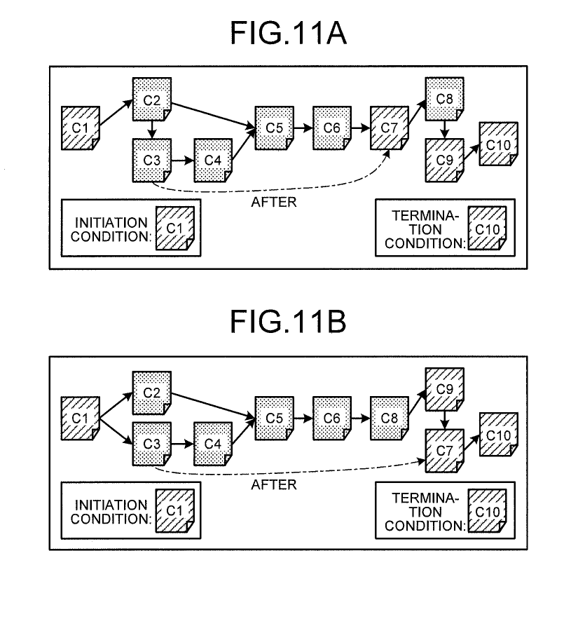

As a result of the above process, when receiving an output display request for an alternative process, the process design apparatus 100 calculates and generates an alternative process, in which the task card “C2”, the task card “C3”, and the task card “C4” that are processes having been executed in parallel are executed in order of “C2”, “C3”, and “C4” as illustrated in FIG. 11-1 for example, and displays the alternative process on the display unit 102.

Furthermore, as illustrated in FIG. 11-2 for example, the process design apparatus 100 calculates and generates a process in which the task cards “C8”, “C9”, and “C7” are executed in this order as an alternative process for the process in which the task cards “C7”, “C8”, and “C9” are executed in this order, and displays the alternative process on the display unit 102.

Warning

An example of the warning output by the process design apparatus 100 will be explained below with reference to FIG. 12. Examples of the constraint include, as illustrated in FIG. 12, various constraints “(some CE.prev) && (non CE.next)”, “(non CS.prev) && (some CS.next)”, “some (CX.prev+CX.next)”, and “CY in CX.*(next)”. That is, the constraint indicates that the process starts by “CS” and terminates by “CE” in such a manner that CX is always used and CY is executed after CX.

When, for example, the task card “CY” is put in a trash box by Drag & Drop, that is, before a constraint indicating that “CY is not used” is added, the process design apparatus 100 outputs a warning for urging a user to re-allocate the task cards because there is no process that simultaneously satisfies the existing constraint described above and a constraint that is to be newly added.

### Advantageous Effects of the Second Embodiment

As described above, the process design apparatus 100 sets constraints in accordance with allocation of task cards, and defines various settings by operations on an editor while a process of generating a satisfactory process is performed in accordance with the set constraints. Therefore, it is possible to flexibly add or modify conditions related to the process design.

Furthermore, the process design apparatus 100 generates a process that satisfies a connection relation, such as a pre-condition or a post-condition, for task cards and in the process including the task cards. Therefore, it is possible to generate a process without inconsistency.

Moreover, the process design apparatus 100 may define various constraints by operating graphics displayed on the editor. Therefore, it is possible to allow a user to visually recognize the connection relation between the task cards, enabling to easily generate a process.

### [c] Third Embodiment

The embodiments of the process design apparatus are explained above. However, The embodiments may be embodied in various different forms other than the above embodiments. Therefore, different embodiments will be described in connection with (1) the icon operation, (2) the structure of the process design apparatus, and (3) a program.

Icon Operation

In the above embodiments, the examples are explained in which the allocation of the task cards and setting of the constraints according to the allocation are performed by Drag & Drop of the task cards or by the icon operations that appear after the allocation operation. However, the icon operations are not limited to the examples described above.

For example, as for the icon operations on the task cards, various icon operations are possible such that an icon setting appears by a right click or a task card is deleted by a double click. The icon operations do not necessarily depend on the Alloy language described in the above embodiments, and may be performed in the above manner with various other languages.

Structure of the Process Design Apparatus

The process procedures, the control procedures, specific names, information including various types of data and parameters (for example, information included in the “constraint definition information 111”) may be arbitrarily changed unless otherwise specified.

The components of each device illustrated in the drawings are only for conceptually illustrating the functions thereof and are not necessarily physically configured as illustrated in the drawings. In other words, the specific forms of separate or integrated devices are not limited to those illustrated in the drawings. For example, the process generating unit 122 and the display output control unit 123 may be integrated into a “process processing unit” that generates a process that satisfies constraints and causes the display unit 102 to display the generated process. All or part of the device may be configured by functionally or physically separating or integrating any of the units depending on various loads or use conditions. Furthermore, all or any part of the process functions performed by each device may be implemented by a CPU and by programs analyzed and executed by the CPU or implemented as hardware by wired logic.

Program

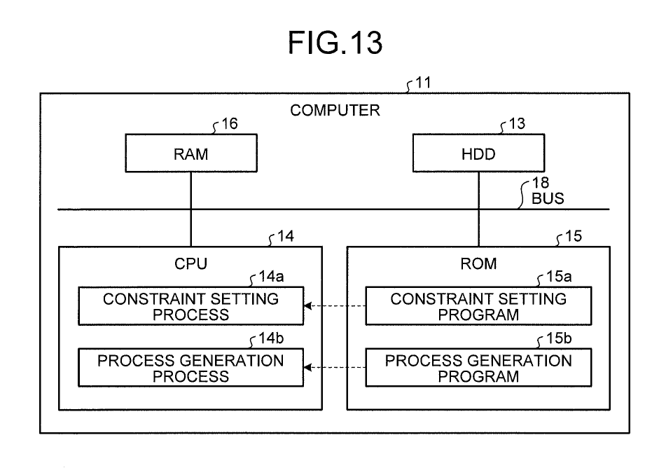

In the above embodiments, a case is explained in which various processes are performed by hardware logic. However, it is possible to realize the various processes by causing a computer to execute a computer program that is prepared in advance. An example of a computer that executes a process design program having the same functions as those of the process design apparatus 100 described in the above embodiments will be explained below with reference to FIG. 13. FIG. 13 is a diagram illustrating the computer that executes the process design process.

As illustrated in FIG. 13, a computer 11 as the process design apparatus 100 includes an HDD 13, a CPU 14, a ROM 15, and a RAM 16 that are connected to one another via a bus 18.

In the ROM 15, a process design program that implements the same functions as those of the process design apparatus 100 described in the above embodiments, i.e., a constraint setting program 15a and a process generation program 15b, is stored in advance. The programs 15a and 15b may be appropriately integrated or disintegrated, similarly to the components of the process design apparatus 100 illustrated in FIG. 2.

The CPU 14 reads the programs 15a and 15b from the ROM 15 and executes the programs, so that the programs 15a and 15b function as a constraint setting process 14a and a process generation process 14b as illustrated in FIG. 13. The processes 14a and 14b respectively correspond to the constraint setting unit 121 and the process generating unit 122 illustrated in FIG. 2.

The CPU 14 executes the process design program on the basis of data (for example, the constraint definition information) recorded in the RAM 16.

The above programs 15a and 15b need not be initially stored in the ROM 15. For example, the programs 15a and 15b may be stored in a “portable physical medium”, such as a flexible disk (FD), a CD-ROM, a DVD disk, a magnet-optical disk, or an IC card, that is inserted into the computer 11; a “fixed physical medium”, such as a hard disk drive (HDD) that is provided inside or outside the computer 11; or “another computer system (or a server)” that is connected to the computer 11 via a public line, the Internet, LAN, WAN, or the like, so that the computer 11 can read out and execute the programs from these media.

1. A non-transitory computer readable medium storing therein a program causing a computer to execute:
setting, in accordance with allocation of a task in a process which has at least two tasks as a predetermined processing unit, a constraint which is related to the process or the task or a combination thereof; and
generating a process that satisfies the constraint set, on the basis of constraint definition information that defines the constraint.

2. The non-transitory computer readable medium according to claim 1, wherein
the generating includes calculating an alternative process for the process that satisfies the constraint set on the basis of the constraint definition information.

3. The non-transitory computer readable medium according to claim 1, wherein
the generating includes displaying a warning for urging re-allocation of the tasks when the process that satisfies the constraint set is not present.

4. The non-transitory computer readable medium according to claim 3, wherein
the displaying includes displaying the process generated.

5. A process design apparatus comprising:
a constraint setting unit that sets, in accordance with allocation of a task in a process which has at least two tasks as a predetermined processing unit, a constraint which is related to the process or the task or a combination thereof; and
a process generating unit that generates a process that satisfies the constraint set by the constraint setting unit, on the basis of constraint definition information that defines the constraint.

6. A process design method comprising:
setting, in accordance with allocation of a task in a process which has at least two tasks as a predetermined processing unit, a constraint which is related to the process or the task or a combination thereof; and
generating a process that satisfies the constraint set, on the basis of constraint definition information that defines the constraint.

7. A process design apparatus comprising:
a processor; and
a memory, wherein the processor executes:
setting, in accordance with allocation of a task in a process which has at least two tasks as a predetermined processing unit, a constraint which is related to the process or the task or a combination thereof; and
generating a process that satisfies the constraint set, on the basis of constraint definition information that defines the constraint.
